(19) United States
(12) Patent Application Publication
(10) Pub. No.: US 2005/0226396 A1
(43) Pub. Date: Oct. 13, 2005

(54) Caller independent disambiguation for interactive voice response systems

(75) Inventors: Brent L. Davis, Deerfield Beach, FL (US); Vanessa V. Michelini, Boca Raton, FL (US); Melanie D. Polkosky, Boynton Beach, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/812,379

(22) Filed: Mar. 29, 2004

(51) Int. Cl. H04M 11/00

(52) U.S. Cl. 379/88.16

(57) ABSTRACT

A method, system and apparatus for caller independent disambiguation for interactive voice response (IVR) systems. A caller-independent disambiguation method for use in an IVR system can include sorting a set of matching records according to counter values associated with corresponding ones of the records. The counter values can indicate a number of times that a corresponding one of the matching records had previously been selected by other callers without regard to any specific caller. The method further can include audibly presenting the sorted set in sequence through the IVR system. Finally, the method can include accepting a selection of a specific record in the set.

### BACKGROUND OF THE INVENTION

1. Statement of the Technical Field

The present invention relates to the field of interactive voice response systems, and more particularly to disambiguation methods for interactive voice response systems.

2. Description of the Related Art

Interactive voice response (IVR) systems perform a critical role in the customer service industry by providing an essential reduction in operating costs in terms of avoiding the use of expensive human capital in processing incoming telephone calls. Generally, IVR systems include speech recognition and text-to-speech processing capabilities coupled to a script defining a call flow. Consequently, IVR systems can be utilized to provide a voice interactive experience for callers just as if a live human had answered and processed the telephone call.

IVR systems have proven particularly useful in adapting Web based information systems to the audible world of voice processing. While Web based information systems have been particularly effective in collecting and processing information from end users through the completion of fields in an on-line form, the same also can be said of IVR systems. In particular, Voice XML and equivalent technologies have provided a foundation upon which Web forms have been adapted to voice. Consequently, IVR systems have been configured to undertake complex data processing through forms based input just as would be the case through a conventional Web interface.

Often, forms based processing can involve data lookups based upon information provided in one or more fields of an on-line form. Examples include query building and the auto-completion of a field in the form. While providing complex data input such as alphanumeric input through a visual interface can be of no consequence, the same cannot be said of the voice interface of an IVR systems. Specifically, prompting an end user audibly for information necessary to process a request can be limited by the nature of an audible user interface, while a visual interface can provide extensive and complex queues for prompting an end user for information. Consequently, the limited ability of an IVR system to prompt an end user for suitable input can give rise to ambiguities in the processing of voice input.

In many cases, IVR systems can avoid the use of voice processing and speech recognition technologies by permitting DTMF based input. Yet, even where DTMF based input can be used to provide input to a field in an IVR system, the limited number of keys in a telephone keypad inherently can provide ambiguities in the processing of DMTF input. Specifically, any one key on the keypad can represent up to three or four different letters or numbers. As a result, one or more disambiguation processes can be required to determine the desired input for a field. Disambiguation processes though helpful, can be cumbersome where overused. Accordingly, a minimal number of disambiguation cycles will be preferred in the course of handling field input in an IVR system.

The prototypical ambiguity encountered in the use of an IVR arises when end user input of a name results in multiple records matching the end user supplied name. In the case of a visual interface, the three matching records can be visually rendered concurrently along with additional disambiguating fields without delay and the end user can disambiguate the selection with a simple keyboard or mouse action. In the context of the audible user interface of an IVR system, however, the end user must be presented with the list of matching records in sequence. To the extent that many records are found to have matched the end user input, conventional audible disambiguation can be painfully tedious.

As it will be apparent to the skilled artisan, ordering a listing of matching records requiring disambiguation can be important where the listing includes many records to be text-to-speech presented through an audio user interface. Several solutions have been proposed which sort the listing of matching records based upon the previously observed behavior of the end user. For example, in one known solution, records are sorted according to the number of times the calling end user has requested the record through the IVR system. Those records which are more often requested by the calling end user are placed at the top of the list while those records which are least often requested by the calling end user are placed at the bottom of the list.

Those caller-dependent methodologies for ordering the listing of matching records requiring disambiguation can be effective in a closed universe where all callers are known and where the behavior of all callers can be tracked with some accuracy. Reality suggests, however, that IVR systems are seldom deployed in a closed universe environment where all callers are known and where the behavior of all callers can be tracked with some accuracy. Rather, most IVR systems are deployed in a manner where the identity of the calling party seldom is known and where little is known of the previous behavior of the calling party. Thus, a caller independent methodology would be preferred.

### SUMMARY OF THE INVENTION

The present invention addresses the deficiencies of the art in respect to disambiguating records in an IVR system and provides a novel and non-obvious method, system and apparatus for caller independent disambiguation for IVR systems. A caller-independent disambiguation method for use in an IVR system can include sorting a set of matching records according to counter values associated with corresponding ones of the records. The counter values can indicate a number of times that a corresponding one of the matching records had previously been selected by other callers without regard to any specific caller. The method further can include audibly presenting the sorted set in sequence through the IVR system. Finally, the method can include accepting a selection of a specific record in the set. Once the record has been selected, a counter associated with the selected specific record can be incremented.

In a preferred aspect of the invention, the IVR system can be a voice activated dialer. As such, the method also can include the step of dialing a person associated with the selected specific record. Moreover, the accepting step can include the step of accepting a voice selection of a specific record in the set. Alternatively, the accepting step can include the step of accepting a DTMF selection of a specific record in the set. In either circumstance, callers can be presented with a set of matching records which have been sorted in such a way as to increase the likelihood that an earlier presented record will be the record desired to be selected by the caller.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an IVR system configured for caller-independent disambiguation; and,

FIG. 2 is a flow chart illustrating a process for caller-independent disambiguation in an IVR system.

### DETAILED DESCRIPTION OF THE PREFERRED EMBODIMENTS

The present invention is a method, system and apparatus for the caller-independent disambiguation of multiple records in an IVR system. In accordance with the present invention, records which can be accessed through the audio user interface of the IVR system can be associated with respective counters. The counter for each of the records can be incremented whenever the record is selected by a caller from among other ones of the records. Whenever a query of the records produces multiple possible matching records, disambiguation will be required in order to select a particular one of the multiple possible matching records.

In the disambiguation process, the multiple possible matching records can be sorted according to the corresponding counters. Consequently, the sorted multiple possible matching records can be presented sequentially to the caller through the IVR system so that the records having the highest valued counters are presented first. The caller, in turn can select the desired record from among the sorted multiple possible matching records. Probabilistically, it will be more likely that the caller will select a record presented earlier in the disambiguation process rather than later based upon the counters. As a result, the IVR can demonstrate a higher level of responsiveness, regardless of the identity of the caller.

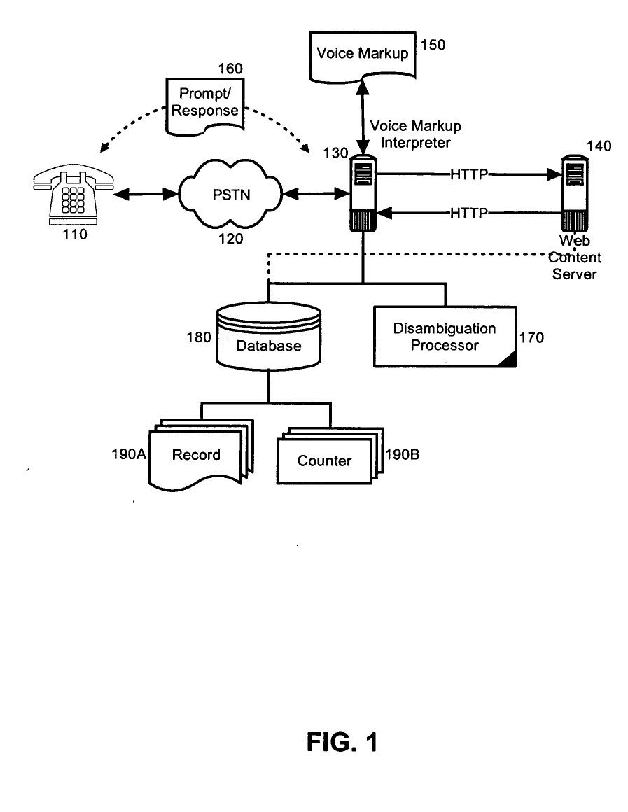

In further illustration of the foregoing inventive arrangements, FIG. 1 is a schematic illustration of an IVR system configured for caller-independent disambiguation. The IVR system can include a voice markup interpreter 130 configured for communicative linkage to one or more callers 110 over the PSTN 120. Though not shown, the voice markup interpreter 130 further can be configured for communicative linkage to one or more voice or DTMF clients over a data communications network where the voice clients have been configured for telephonic access using the data communications network, as is well-known in the IP telephony art.

The voice markup interpreter 130 can be programmed for standalone processing of voice markup 150. The voice markup interpreter 130 further can be configured for cooperative processing between the voice markup 150 and data content provided by a content server 140 coupled to the voice markup interpreter 130. In either circumstance, the voice markup interpreter 130 can be configured to process prompts and responses 160 from and to the callers 110 as defined according to the voice markup 150. Through the prompt and response mechanism, callers 110 can interact with the logic specified by the voice markup 150. Exemplary logic can include a voice activated dialer system in which callers can voice specify the automatically dialing of a spoken name. Still, the skilled artisan will recognize that the IVR system of the present invention is not limited strictly to the interpretation of voice markup 150 and the IVR system can be configured for direct programmatic operation.

The IVR system can include a database 180 which can include data stored in records 190A which can be accessed within the IVR system, either internally or by the callers 110. Optionally, the database 180 can be coupled to a back end content server 140 which can access the records 190A disposed therein. Importantly, each of the records 190A can have a corresponding one of the counters 190B. Each of the counters 190B can be incremented whenever the corresponding one of the records 190A is accessed by one of the callers 110. Significantly, each of the counters 190B can be incremented responsive to one of the callers 110 accessing a corresponding one of the records 190A, without regard to the identity of the accessing one of the callers 110. An example follows:

| Full Name | Location | Department | Counter |
|---|---|---|---|
| Michelini, Vanessa | Boca Raton | Voice Systems Service | 10 |
| Davis, Brent | Boca Raton | Voice Systems Service | 50 |
| Polkosky, Melanie | Tampa | Human Factors | 20 |
| Davis, Brent | Yorktown | Human Resources | 5 |
| Davis, Brent | Austin | Sales | 15 |

A disambiguation processor 170 can be communicatively linked to the database 180. In particular, the disambiguation processor 170 can access a result set of the records 190A provided by the database and corresponding ones of the counters 190B. In order to facilitate the selection of a particular one of the records in the result set, the disambiguation processor 170A can prompt callers with their respective result sets so that the callers can select a desired record. To probabilistically enhance the likelihood that the desired record will be audibly presented to a caller sooner rather than later, the result set can be sorted by the disambiguation processor 170 from highest counter value to lowest counter value and presented in to the caller in sorted order.

For instance, in reference to the above table, in a voice activated dialer, the IVR system can prompt a caller for the name of a person to whom a call is to be placed by the voice activated dialer. The caller can respond with the name “Brent Davis”. The IVR system can query a database of contacts and can retrieve a set of three matching records: Brent Davis in Boca Raton, Brent Davis in Yorktown and Brent Davis in Austin. Consequently, the IVR system can sort the set from highest associated counter to lowest. The IVR system then can begin a sequential replay of the sorted set, beginning with Brent Davis of Boca Raton. The caller can barge-in by selecting the Brent Davis from Boca Raton entry without requiring the complete audible presentation of the entire set.

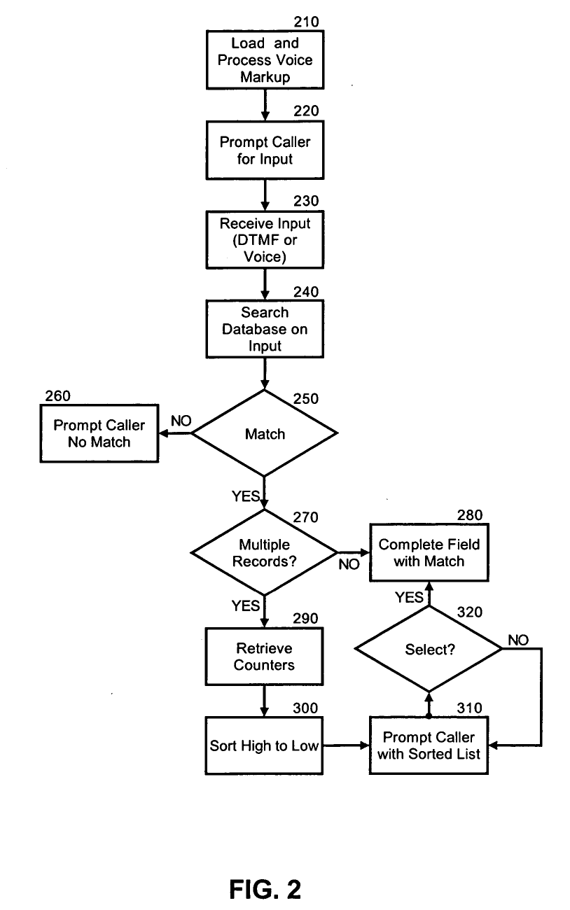

In more particular illustration, FIG. 2 is a flow chart illustrating a process for caller-independent disambiguation in an IVR system. Beginning in block 210, voice markup can be loaded and processed for conducting a session through the IVR system. In block 220, a caller to the session can be prompted to provide input. In block 230, the IVR system can receive input from the caller, for example voice input or DTMF input. In response, in block 240 the caller provided input can be used to query the database to locate a particular desired record. If in decision block 250 no match can be found in consequence of the query, in block 260 the caller can be prompted with a no match condition. Otherwise, the process can continue through decision block 270.

In decision block 270, if multiple records are not located in response to the query, in block 280 the single match can be used to complete a field in the course of the IVR session and the counter associated with the single match can be incremented (though in other embodiments, the single match can be used in other programmatic ways). If, however, multiple records are located in response to the query, in block 290 the counters for the multiple records can be retrieved. In block 300, the multiple records can be sorted from the highest associated counter to the lowest associated counter and in block 310 the caller can be prompted with the sorted list of multiple matching records. If in decision block 320 a particular record among the sorted list is selected, in block 280 the single match can be used to complete a field in the course of the IVR session and the counter associated with the single match can be incremented.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, control the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in an language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A caller-independent disambiguation method for use in an interactive voice response (IVR) system, the method comprising the steps of:
sorting a set of matching records according to counter values associated with corresponding ones of said records, said counter values indicating a number of times that a corresponding one of said matching records had previously been selected by other callers;
audibly presenting said sorted set in sequence through the IVR system; and,
accepting a selection of a specific record in said set.

2. The method of claim 1, further comprising the step of incrementing a counter associated with said selected specific record.

3. The method of claim 1, further comprising the step of dialing a person associated with said selected specific record.

4. The method of claim 1, wherein said accepting step comprises the step of accepting a voice selection of a specific record in said set.

5. The method of claim 1, wherein said accepting step comprises the step of accepting a DTMF selection of a specific record in said set.

6. An IVR system configured for disambiguation, the system comprising:
a database comprising multiple data records, each of said data records having a corresponding counter indicating a number of times that a corresponding one of said data records has been selected by callers to the IVR system; and,
a disambiguation processor communicatively linked to said database and programmed to disambiguate a set of said data records by sorting said set of said data records in said set from highest counter value to lowest counter value, and audibly presenting said sorted set to a caller.

7. The IVR system of claim 6, further comprising a voice markup interpreter coupled to said disambiguation processor.

8. A machine readable storage having stored thereon a computer program for caller-independent disambiguation in an interactive voice response (IVR) system, the method comprising, the computer program comprising a routine set of instructions which when executed by a machine cause the machine to perform the steps of:
sorting a set of matching records according to counter values associated with corresponding ones of said records, said counter values indicating a number of times that a corresponding one of said matching records had previously been selected by other callers;
audibly presenting said sorted set in sequence through the IVR system; and,
accepting a selection of a specific record in said set.

9. The machine readable storage of claim 8, further comprising the step of incrementing a counter associated with said selected specific record.

10. The machine readable storage of claim 8, further comprising the step of dialing a person associated with said selected specific record.

11. The machine readable storage of claim 8, wherein said accepting step comprises the step of accepting a voice selection of a specific record in said set.

12. The machine readable storage of claim 8, wherein said accepting step comprises the step of accepting a DTMF selection of a specific record in said set.
